(19) United States
(12) Patent Application Publication
(10) Pub. No.: US 2002/0107592 A1
(43) Pub. Date: Aug. 8, 2002

(54) Panel search engine for digital sound processing systems

(76) Inventor: David Iain Craig, Menlo Park, CA (US)

Correspondence Address: CENTRAL COAST PATENT AGENCY, PO BOX 187, AROMAS, CA, 95004, US

(21) Appl. No.: 09/778,202

(22) Filed: Feb. 6, 2001

(51) Int. Cl. H04B 1/20; G06F 17/00; H04B 1/00

(52) U.S. Cl. 700/94; 381/119; 369/4

(57) ABSTRACT

A diagnostic tool for an audio mixing system has an information source storing at least interconnection characteristics and apparatus settings in the system, relative to channel inputs, a search function accessible by a user, which upon initiation polls the information source, and search criteria associated with the search function for establishing specific information to be matched in a search. Initiation of the search function causes the search function to poll the information source, and to return channel numbers for those channels that match the search criteria. Criteria can be specific to hardware and/or software.

### FIELD OF THE INVENTION

The present invention is in the field of digital signal processing, and has particular application in the management of digital audio system channels.

### BACKGROUND OF THE INVENTION

Of all the arts, music has probably been changed the most pervasively by digital technology. Prior to the advent of modern digital equipment that could record entire real-time tracks for later software editing, musicians, working in a recording studio, were reliant upon sound engineers to cue tapes to specific problems spots, and then were required to play, out of context, only the small portion of the performance needing correction. This process, referred to as “punching in”, was time-consuming and labor-intensive, and, with many musicians, often fostered negative attitudes toward making music in a studio.

The process has since been replaced in most modern studios with digital recording techniques allowing musicians to play entire “takes” of their parts in real-time, with all the phrases in context. By utilizing such techniques the music created and recorded onto digital medium, such as a compact disk or digital audio tape, is in the form of digital data. As such, it shares the great benefits of all digitally encoded information, such as being perfectly reproducible and completely editable.

In many forms of digitally recorded modern music, many of the sonorities and instrumental voices originate from within digital equipment, and the layering of the many tracks that make up a performance is entirely computer-based. Digital composition, recording and editing techniques have greatly enhanced the attitudes and creative options of the musicians, producers and editors.

A typical modern recording and mixing studio contains digital signal processing systems of sophisticated functionality, consisting of separate functional units, such as a digital recording apparatus for processing and saving of digital signals, and an apparatus enabling playback of the digital recording. Another key digital component of such a digital signal processing system is an apparatus for changing, and combining or mixing of signal strength and characteristics, signals from usually more than one signal or sound source. The process of mixing, or the final combination of tracks onto one composite soundtrack, takes place typically in a special console equipped with separate controls for each track to adjust loudness and various aspects of sound quality. New digital processes often employ a process of building sound track-by-track onto a single digital audio tape, for example, a process known in the art as overdubbing. A modern digital audio mixing system, used for this purpose, usually consist of several main functional units, including a mixing desk with a control surface, a digital mixer core, interfaces for conversion between digital and analog signals, and such a mixer can be configured with a variety of software programs to manage such functions as system set up, file management, patching and many other functions.

A significant improvement in performance was achieved by the advent of digital technology into audio mixing consoles, not only by the obvious advantages of digital data processing, but also because a digital audio mixing console clearly separates the mixing desk and the mixing engine of the system, whereas, in an older analog system, for example, audio data signals actually flow through connections to various manual control apparatus of the control surface. The post-processed audio signals of a digital system are therefore typically greatly superior in sound quality to those output by an analog system.

In a digital audio mixing system audio signals flow through the input of the mixing engine, are processed by various functions, each function processing both input and output signals. The signals are communicated through the system via circuits, or buses, which connect various devices to digital processors within the system. Audio signals from different signal sources, recorded tracks of many different instruments, for example, are separated by channels which can be independently controlled by sliders or other controls at the mixer control surface. The control of separate channels actuated at the mixing desk and performed by the mixing engine can be enabled by parameters configured into a mixing console software program. Such techniques allow a user to perform a multitude of channel control actions, including specifying mixes and combinations of channels, mix and group buses, and so on.

The hardware and software of many modern digital audio mixing systems of current art are designed to support a substantial number of separate channels. Each channel can be independently controlled through parameters previously set up between the control surface of the mixing desk and the mixing engine. It is important for a sound engineer, when processing signals utilizing such a digital audio mixing system, to be able to isolate and monitor any particular channel desired. The task of identifying such a problem channel is made much more difficult for the sound engineer when a large number of buses and channels are used in the mixing system, typical of modern digital audio mixing systems, which are often expandable to include even more buses and channels.

What is clearly needed is a channel location system and method allowing a user to perform a search and to thereby easily locate any desired channel within the system. Such a system and method enables a user to locate a problem channel, for example, based on search criteria, regardless of whether the channel is obviously visible to the user or not.

### SUMMARY OF THE INVENTION

In a preferred embodiment of the present invention a diagnostic tool for an audio mixing system is provided, comprising an information source storing at least interconnection characteristics and apparatus settings in the system, relative to channel inputs, a search function accessible by a user, which upon initiation polls the information source, and search criteria associated with the search function for establishing specific information to be matched in a search. Initiation of the search function causes the search function to poll the information source, and to return channel numbers for those channels that match the search criteria.

In some embodiments there are monitoring interfaces to individual ones of channels in the audio mixing system, wherein the search function samples real-time characteristics at said interfaces in individual channels comparing the samples with search criteria The monitoring interfaces may include at least one audio monitoring interface, wherein the search function samples real-time audio in a channel for comparison to an audio characteristic specified in search criteria.

Also in some embodiments the tool further comprises a facility for saving instances of the search function each with a name related to specific criteria attached, and for selecting and initiating individual ones of the named search functions to perform the associated search and to return channels found in the search. In some cases the facility for selecting and initiating comprises a display apparatus for displaying individual ones of the search functions by name and selection inputs for selecting individual ones of the displayed search functions, to initiate the associated search. Still further, in some embodiments the tool further comprises a function for assigning channels returned by a search to specific ones of control strips of the mixer desk.

In another aspect of the invention an audio mixing system is provided, comprising a mixer desk including a user interface and control apparatus, a mixing engine coupled to the mixer desk for mixing audio on input channels and providing an audio output, computerized controls for managing activities of the mixing system, and a diagnostic tool including an information source storing at least interconnection characteristics and apparatus settings in the system, relative to channel inputs, a search function accessible by a user, which upon initiation polls the information source, and search criteria associated with the search function for establishing specific information to be matched in a search. The system is characterized in that initiation of the search function causes the search function to poll the information source, and to return channel numbers for those channels that match the search criteria.

In some embodiments of the system there are monitoring interfaces to individual ones of channels in the audio mixing system, wherein the search function samples real-time characteristics at said interfaces in individual channels comparing the samples with search criteria. In some embodiments the monitoring interfaces include at least one audio monitoring interface, wherein the search function samples real-time audio in a channel for comparison to an audio characteristic specified in search criteria.

In some embodiments there is a facility for saving instances of the search function each with a name related to specific criteria attached, and for selecting and initiating individual ones of the named search functions to perform the associated search and to return channels found in the search. The facility for selecting and initiating may comprise a display apparatus for displaying individual ones of the search functions by name and selection inputs for selecting individual ones of the displayed search functions, to initiate the associated search. There may also be a function for assigning channels returned by a search to specific ones of control strips of the mixer desk.

In still another aspect of the invention a method for diagnosing problems in an audio mixing system having individual channels for audio inputs to the system is provided, comprising the steps of (a) preparing a generic search function capable of polling an information source in the system, the information source storing at least interconnection characteristics and apparatus settings in the system, relative to channel inputs; (b) assigning search criteria to individual instances of the generic search function, creating thereby specific search functions; and (c) initiating individual ones of the specific search functions to poll the information source, and to return channel numbers for those channels that match the specific search criteria.

In some embodiments of the method there are monitoring interfaces to individual ones of channels in the audio mixing system, and, in step (c), the search function samples real-time characteristics at said interfaces in individual channels comparing the samples with the search criteria. Also in some embodiments the monitoring interfaces include at least one audio monitoring interface, wherein the search function samples real-time audio in a channel for comparison to an audio characteristic specified in search criteria.

In some cases the method further comprises a facility for saving instances of the search function each with a name related to specific criteria attached, and for selecting and initiating individual ones of the named search functions to perform the associated search and to return channels found in the search. The facility for selecting and initiating may comprise display apparatus for displaying individual ones of the search functions by name and selection inputs for selecting individual ones of the displayed search functions, to initiate the associated search. There may also be a function for assigning channels returned by a search to specific ones of control strips of the mixer desk.

In various embodiments of the present invention, taught in enabling detail below, for the first time a reliable and effective tool is provided for diagnosing problems in audio mixing situations.

### BRIEF DESCRIPTION OF THE DRAWING FIGURES

FIG. 1 is a simplified diagram of the architecture of a digital mixing console in the art.

FIG. 2 is a simplified partial view of control elements of a digital mixing console in the art.

FIG. 3 is an enlarged view of channel select keys of the digital mixing console of FIG. 2.

FIG. 4 is an enlarged view of the display panel of the digital mixing console of FIG. 2, showing a channel layout according to conventional art.

FIG. 5 is a block diagram of elements of a mixing system for a preferred embodiment of the present invention.

FIG. 6 is an enlarged view of the display panel of FIG. 2, showing a smart channel layout according to an embodiment of the present invention.

### DESCRIPTION OF THE PREFERRED EMBODIMENTS

As previously described, a difference between modern digital audio mixing systems, and previous systems, using analog technology for example, is that a separation of the mixing desk and mixing engine is present in a digital audio mixing system. This is a key improvement to analog systems where audio data signals flow through connections to the various manual control apparatus of the actual mixing desk. In a digital audio mixing system the processing of digital audio data is performed by the mixing engine and completely controlled by the mixing desk.

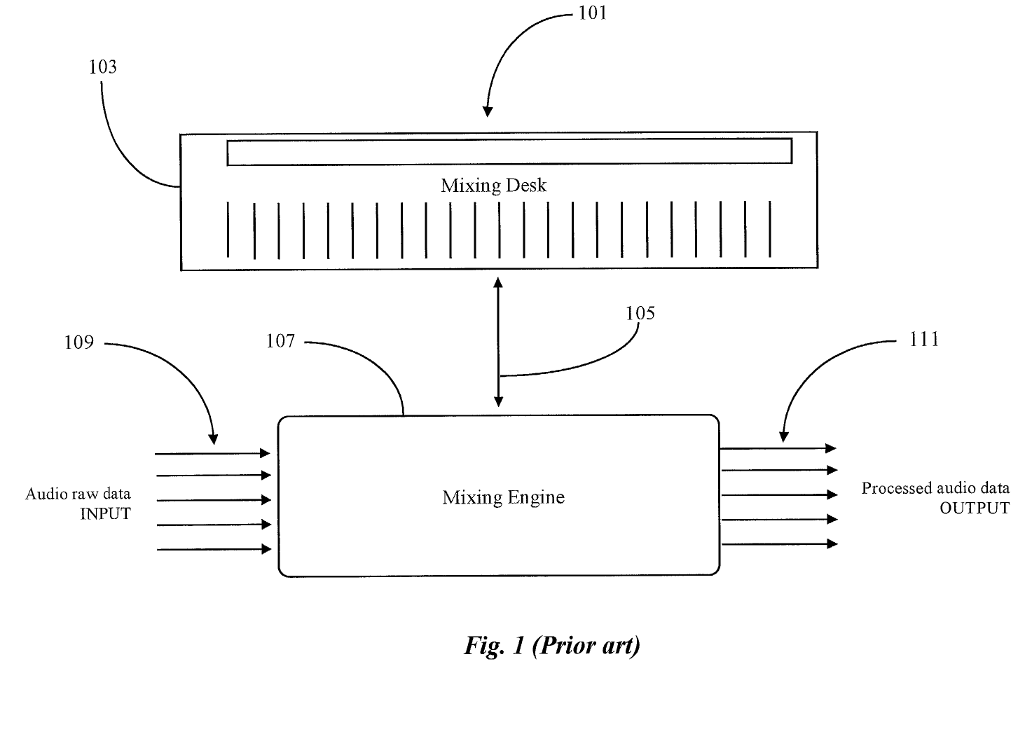

FIG. 1 is a simplified diagram of architecture of a digital mixing console. Digital mixing console 101 has a mixing desk 103 that can contain a variety of control knobs, sliders and other apparatus, situated on a control surface similar to any common audio mixer. Such a nixing desk can also have various display screens for monitoring functions, tracks, channels and so on. For reasons of clarity, detail of such elements is not shown in FIG. 1, as they are not particularly pertinent to the invention.

Mixing engine 107 can be described as the digital core of the system, and performs the actual digital signal processing. Raw digital audio data flows into mixing engine 107 through input 109, is processed by various functions, each of which has at least one signal input and one signal output. Within the mixing engine, the produced output signals of each function are typically used as input signals for other functions. Various software configurations are used in such a digital mixing engine for performing many functions such as specifying a combination of channels, auxiliary sends, and mixing or grouping circuits, for example. Such software configurations can vary greatly in type and function, depending on the application for which the digital audio mixing system is being used. Other software can also exist for the purpose of managing such operations as system set-up, file management and storing and recalling patches.

Process digital audio data flows out from the mixing engine through output 111 and can then be sent to a recording apparatus or elsewhere for further processing. As previously described, mixing desk 103 directly and completely controls the functions of mixing engine 107, through parameters configured into the system, represented in this diagram as parameters 105, and therefore no audio data, either analog or digital, actually flows through mixing desk 103. For example, a scale function scales a particular audio signal according to a slider apparatus input on the control surface of the mixing desk, and specific parameters set for the control.

A digital mixing console such as console 101, combining mixing desk and mixing engine, can be described as a network of signal paths (often virtual) where an often large number of digital audio functions are combined. Each audio signal is communicated through the system via circuits, or buses, that connect the main system processor to various devices in the mixing system, controlling functions for example. The mixing desk directly controls the functions by a set of rules or parameters configured into the system.

A typical digital audio mixing console requires a large amount of processing power, of such scope that can only efficiently be performed by a plurality of digital signal processors. Such an array of processors needs an interprocessor communication network having a very high bandwidth to provide the necessary data exchange between the many audio functions performed by the mixing engine. In many modern digital mixing systems, the interprocessor communication network is designed directly into the hardware, because a software-controlled communication network often does not satisfy the strict requirements of speed, or utilizes too much processing power. As a result, the communication network can be inflexible and changes in the digital data flow of audio signals can be difficult. To overcome such a lack of communication speed and routability of data, special high-bandwidth interprocessor communication structures are designed in current art allowing communication of up to several hundred internal audio channels autonomously without increasing the processing power.

Many digital audio mixing systems in current art have a programmable architecture, full edit system control over all mixer functions, and often an ability to handle both analog and digital inputs. For data routing, processing and operation, some digital audio mixing systems have a plurality of processor cards, which determine the number of channels and circuits, or buses, within the system. For a given number of processing cards, different combinations of channels and buses may be configured using special software, providing such capabilities as output for recording and monitoring, mixing and grouping of channels, and so on. In some systems, the processing power can be upgraded to increase the number of channels and buses.

Many channels and buses can exist in a digital audio mixing system as described, providing many different functions and mixing capabilities. One type of bus common in digital audio mixing systems is known as a ring bus. The data that is communicated on this specialized circuit can be described as a set of global channels. Each channel is a digital audio connection between the audio functions on different processors. Each processor produces a certain part of these channels depending on which functions are running on this processor. If two functions on the same processor need a connection, there is no need to use a global audio channel. The audio data can be transferred within the memory of the processor. This is equivalent to a local audio connection. The amount of communicated data is limited by the highest possible clock frequency on the ring bus. At the audio sampling rate of some digital mixing systems, current in the art, up to several hundred global channels can be communicated.

As described in the background section, the mixing desk of a modern digital audio mixing system directly controls the digital signal processing of the mixing engine. The mixing desk has a control surface having varying apparatus for operating and controlling the many different functions of the digital audio mixer. A plurality of channel strips, a grouping of rotating knobs, pushbuttons and sliding faders are typically provided for this purpose. Channel strips are commonly grouped on the control surface to facilitate a logical layout designed specifically to make operation simple fast and intuitive, and are used for changing loudness or other characteristics of the audio data. One or more display devices, commonly utilizing flat panel display apparatus, are often used for monitoring control situations of equalization or dynamics, for example, and viewing active channel names or metering graphics, as well as for monitoring many other aspects. One of the important functions is allocation between above-mentioned strips, and actual channels, in particular, because each strip can have multiple mapping to different channels, as quite often the number of channels far exceeds the number of strips available.

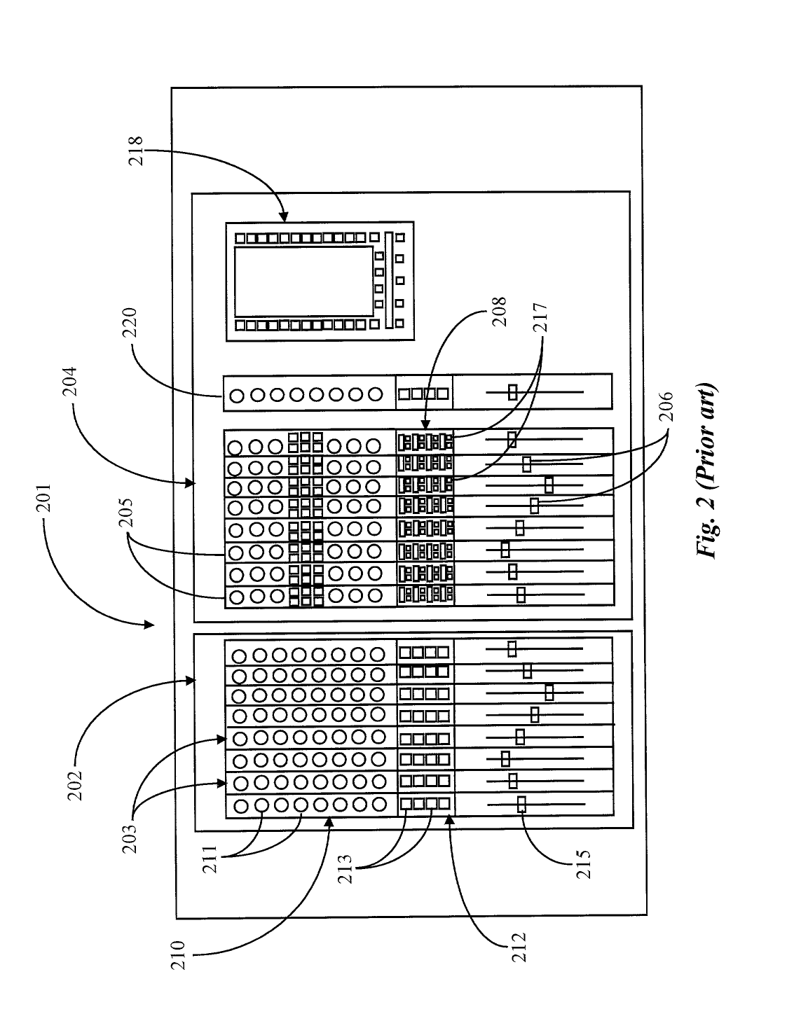

FIG. 2 is a simplified partial view of a control surface 201 of a digital mixing console, such as mixing desk 101 of FIG. 1. Control surface 201 is representative of a digital audio mixing console according to current art. In this simplified view many details and elements not pertinent to descriptions forthcoming in this specification are omitted for reasons of simplicity. Control surface 201 in this example is shown with a normal control section 202 having a total of eight control strips 203. Each control strip 203 is comprised of a plurality of rotatable knobs 211 linearly arranged in a knob section 210, a plurality of keys 213 located in a key section 212, and a strip fader 215 at the bottom of each channel row. The purpose of each control strip 203 is for providing normal control of at least a single channel's audio data characteristics such as loudness, equalization, dynamics and so forth. More than one normal control section can exist in other examples, but for reasons of clarity only control section 202 is shown.

A central control section 204 is shown adjacent to normal control section 202, also having a plurality of rotatable knobs and keys for channel control, but with the addition of a channel select section 208 located in the center of central control section 204. A plurality of strip faders 206 are located just below channel select section 208 and are similar in form and function to strip faders 215 of normal control section 202, except that in addition to providing normal channel control, the functions of strip faders 206 are assignable to provide control of different channels, for example, a channel normally controlled by a control strip in normal control section 202.

In the example represented by control surface 201, a traditional and logically familiar design is used in the function of normal channel strips 203 of control section 202, having a single channel strip that controls a single channel. Also in this example a layering process can be used for the central assignable control strips 205, allowing one channel strip to be assigned to different or multiple channels 203, while in other cases in this example two channel strips can be assigned to control one channel. It is common in many systems of this type to have a center section of strips facilitating central control of any channel. Additional knob sets are included in the center strip section providing control for a variety of additional effects such as equalization, dynamics and so on.

In the example presented a channel can be brought to the central control section from another channel strip elsewhere on the control surface, such as in normal control section 202. A channel strip is typically a section with a finite number of sliders and other controls, such as in this example, which can then be multiplied to form a mixing desk. The channel or channels for movement to the central strip control section can be selected in this example from the separate grouping of sets of channel select keys 217, each set of keys performing the selection of the channel to the center, as well as an on/off or “solo” function. Once control of a channel is moved to the central control section 204, control of that channel is accomplished by central assign strip 220, and control is exactly the same as it was before movement to the central section because all of the controls from the imported strip are also found on the central assign strip 220. Expanded changes to the imported strip, now controlled by central assign strip 220, are made possible with additional knobs, switches and displays located elsewhere in the central control section 204. Details of such additional control elements are also not shown in this view for reasons of simplicity. A panel viewer 218, which is a standard display device with execute keys used in many mixing consoles such as the one described herein, is located adjacent to central strip 220. This is a display panel having a border of keys, such that different displays may be recalled mapping functions to the bordering keys, while providing a displayed label next to individual ones of the keys describing the function that will be executed by selecting a particular key. This ability to relate functions to keys in a virtual manner provides a compact way to concentrate a maximum amount of control in a minimum space.

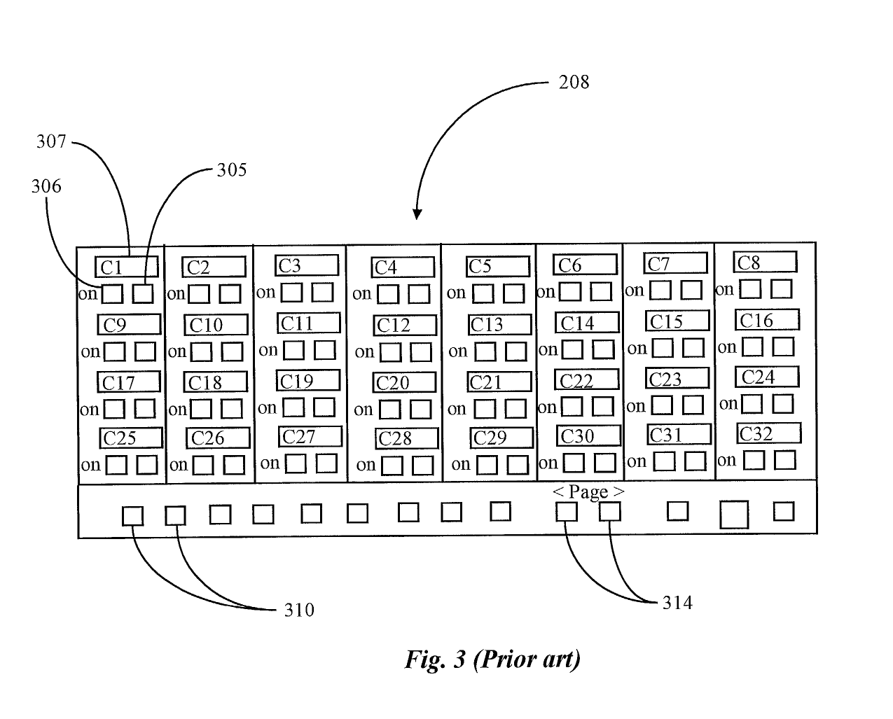

FIG. 3 is an enlarged view of channel select keys of the digital mixing console of FIG. 2. Channel select section 208 is used in this example to enable the user to quickly and easily move around on the mixing console and select various channels, or groups of channels, from elsewhere on the mixing console. Channel select section 208 has, in this example, 32 sets of channel select keys and a small display window associated with each set of channel select keys. Each set of channel select keys comprises a key 305, used for selecting a channel from elsewhere on the console and moving the channel to the central control section, and an adjacent key 306 that can act as an on/off or solo button. Located just above the set of channel select keys 305 and 306 is a small display window 307 showing a channel name, in this case channel “C1”. Each set of the 32 sets of channel select keys and display window shown in this example corresponds to a different channel name as indicated in the display window. In the example shown, by actuating channel select key 305, the control of channel “C1” as displayed in window 307 will be moved to the central control section. Likewise, by actuating right-side keys of other sets of channel select keys, the channel displayed in that associated display window will similarly be moved to the central channel control section. Keys 310, linearly located at the bottom portion of channel select section 208, are used for various additional channel selection and processing, such as swapping or copying and pasting channels, for example. Page keys 314, also located at the bottom of channel select section 208, are used for quickly selecting additional channels for display in display windows 307. For example, 32 different channels are currently displayed in display windows 307, namely channels “C1 through C32”. By actuating page keys 314 the user has the ability to scroll through additional channels quickly. The function of page keys 314 can also be changed to select control groups of channels.

Due to constraints in the size of a manageable digital audio mixing system, very often multiple channel groups or multiple mixing buses are assigned to only one set of channel strips, because very often the groups or buses are being processed or prepared separately, and then processed all at the same time. It is well known that it is much easier for an engineer utilizing such a system to manage the building of a large and complex sound background by utilizing a process whereas multiple sets of functions are combined or overlayed into one channel control section. As previously described it is possible that there may be unwanted audio data in a particular channel or bus within the digital audio mixing system. When this occurs it is imperative, in order to achieve the cleanest possible post-processed output from the system, that the sound engineer or technician quickly locate and isolate the channel causing the problem in order to easily correct it. A problem experienced by some users, utilizing such a conventional channel location system as described above, is that it can be very difficult to find the specific problem channel in a specific situation, especially true when a very large number of possible channel layouts or programmable overlays exist.

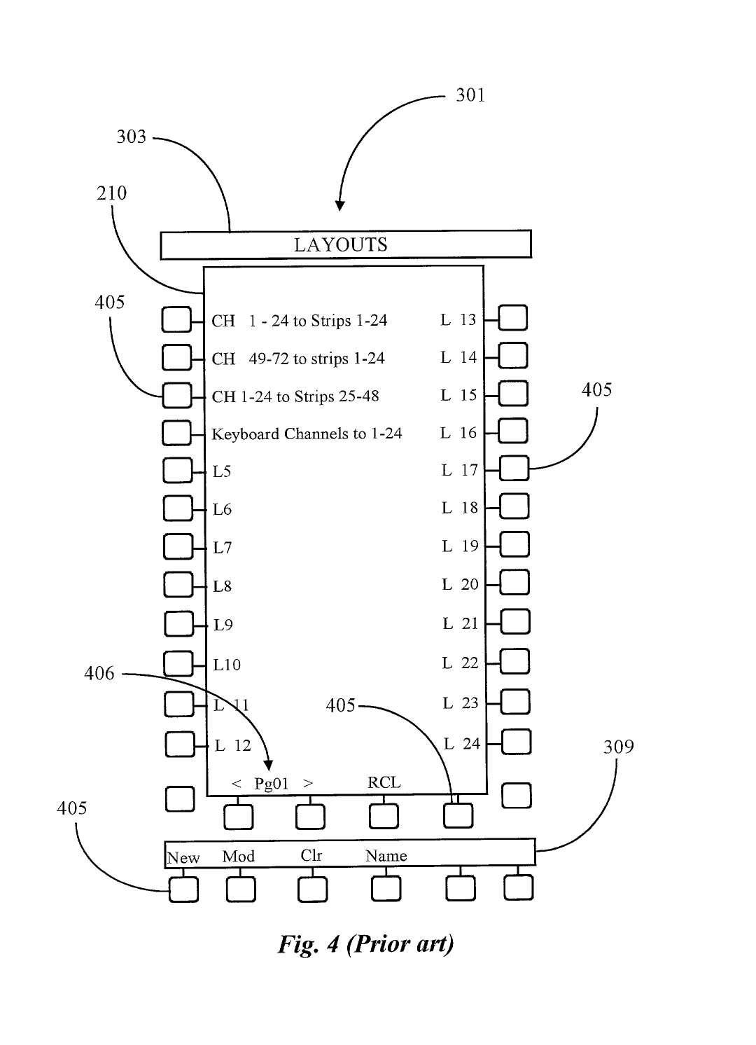

FIG. 4 is an enlarged view of panel viewer 218 of digital mixing console 201 of FIG. 2. In the present example, various functional relationships may be recalled and displayed, providing a broad range of control with the fixed number of keys and the one display. In the present example the different displays and mapping are referred to as pages, and each page may have a title, which is displayed in display strip 401.

One of the pages is a layouts page. A layout is defined as a mapping of channels to control strips of the mixing desk. In FIG. 4 the display is at the Layouts page, and the name is shown in display strip 303. In this example there are four layouts that have been saved, and these defined and saved layouts are shown by name adjacent to the first four of the smart keys 405. In this example the first of the saved layouts simply maps Channels 1-24 to strips 1-24. A second layout maps channels 49-72 to strips 1-24. A third maps channels 1-24 to strips 25-48. A fourth layout maps all keyboard channels to strips 1-24.

In the case of mapping keyboard channels, a default may be such that, if there are fewer than 24 keyboard channels, say 12, the mapping will begin at strip 1 for the lowest numbered channel having a keyboard, and proceed to the right across the board through strip 6. Strips 7 through 24 will then be unassigned. If there are more than 24 keyboard channels, only the first 24 by channel number will be mapped.

When a layout is selected by actuating an execute key 405, an LED or other similar apparatus within or behind execute key 405 illuminates, indicating that the adjacent item or items displayed in display panel 210 are currently selected, and the saved layout is mapped by channels to control strips on the mixing desk. One might well select and deploy more than one layout if the mappings are exclusive relative to the strips, or a priority default may be used.

It will be apparent to the skilled artisan that the number and complexity of layouts may be considerably grander than that shown in this example. Still, even though the layouts scheme allows for complexity, layouts are manually configured and saved in the art. That is, is one wants to map all channels with a keyboard input to some organization of control strips, one must know which channels have keyboard inputs, and manually select and include the proper channels in the layout, then save the layout. If one then physically moves one of the keyboards to an input at a different channel, the layout is no longer correct. The layout will then be wrong until a person goes into the configuration and makes the appropriate correction.

An additional smaller display strip 309 is located below display panel 210, used in this example for the purpose of displaying the names of actions executable by actuation of additional execute keys 405 located directly below display strip 309. As with all execute keys previously described, execute keys 405 associated with display strip 309, take on the function displayed adjacently. In other examples display strip 309 and associated execute keys located below can be used for source selection of mix sections for monitoring. The purpose of display strip 309 and associated execute keys can change depending on the current application.

In the example shown in FIG. 4, up to 24 layouts can be displayed at a time, corresponding to the 24 execute keys 405 located on the sides of display panel 210. In this case a total of four layouts are saved and the names of the layouts are displayed corresponding to four execute keys 405 on the left side of display panel 210. The remaining 20 layout positions, shown as “L 5” through “L 24”, do not yet have a saved layout assigned to the corresponding execute keys 405, and are therefore unnamed, each displaying the default characters as shown.

Additional saved layouts can be displayed by display panel 210 by actuating a page key 406 which will scroll through additional pages of layouts. In the example shown, if the user actuates right-side page key 406 layouts 25 through 48 will be displayed for selection by display panel 210. Actuating the same page key 406 again will display layouts 49 through 72, and so on. A large repertoire of layouts can be saved in a system such as described, but must still be essentially managed. Thus layout management can become increasingly complicated as the number of channels saved into each layout, and the number of saved layouts increases.

In such a large and complex layout, having a number of channels assigned to a number of control strips, an undesirable sound, for instance, may be heard by the user while monitoring, and it is quite possible the user may have great difficulty in quickly locating the channel that is the source of the unwanted sound.

The present invention teaches a method allowing a user to quickly and easily find a problem channel so that corrective action can immediately be performed. This capability is enabled by the configuration and saving of new and novel “smart” layouts, in conjunction with a search facility. In an embodiment of the invention such layouts are presented and described in enabling detail, and are created utilizing a similar process as used for creation and saving of conventional layouts previously described. The concept for such “smart” layouts is that the same interface would exist at the center section of mixer console, as shown in FIG. 4, where a user defines channel layouts and selects certain channel strips onto which to map the channels according to the layout.

In the art, considering a mixing system as described herein, one of the primary motivations is to separate the control hardware and control intelligence from the actual processing and mixing of the various input signals to make a final product (audio output). Referring again briefly to FIG. 1, mixing desk 103, which incorporates and comprises all of the controls, is physically separated from mixing engine 107, which may be in another room, or even in a more remote location. The mixing desk, the communication to the mixing engine, and all control functions in the system are highly computerized, allowing a broad range of control functions, including, but not limited to a Snapshot system that allows the settings of physical controls (as, for example, the control surface shown in FIG. 2) to be recorded and saved, and later recalled and assigned to control strips arbitrarily.

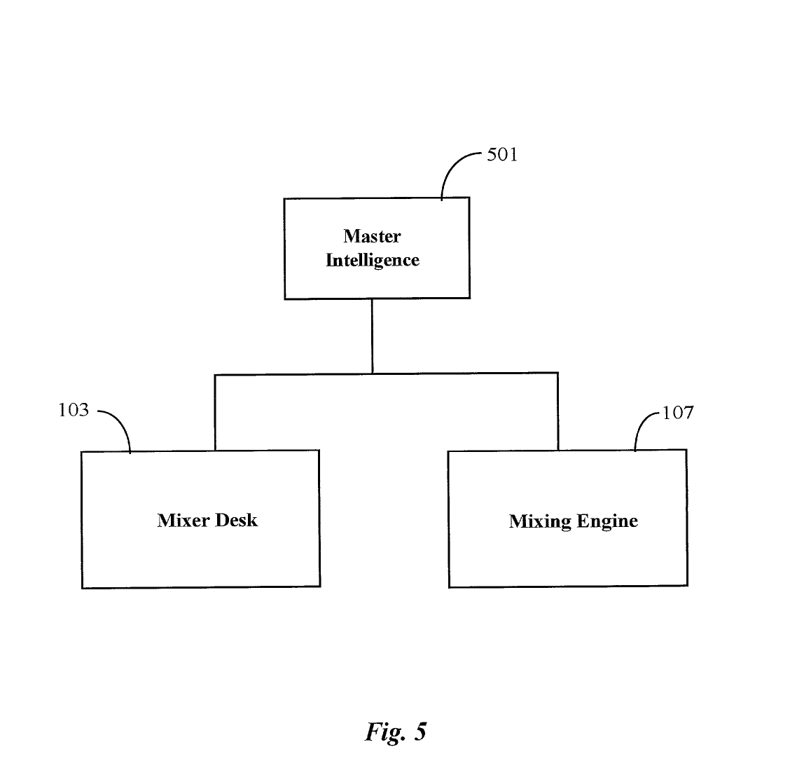

FIG. 5 is a highly simplified diagram showing master intelligence 501, which is accomplished in part in a preferred embodiment by a high-end PC-compatible computer system, in communication with Desk 103 and Engine 107 (of FIG. 1). There are, in addition to the PC-compatible computer system, a number of other intelligent processors and displays in the system. Many of the computer functions are built into the mixing desk, for example, and a master user-interface is provided for high-level functionality. The logical communication paths between the elements in FIG. 5 are intended to represent all of the communication lines and links between the elements, by which sensors and input devices provide information to the system intelligence, and the system intelligence commands other elements to perform control and information output functions.

Overviews, photographs, and descriptions of a system conforming largely to the descriptions herein, and providing considerably more detail, are available from the Website WWW.euphonix.com, under the heading of System 5. This material, available to the public at the time of filing this patent application, is incorporated herein by reference.

Given the above descriptions and the incorporated material, it should be quite clear to person of ordinary skill, following this discussion, that there is considerable computer intelligence, memory, and interconnection in the system.

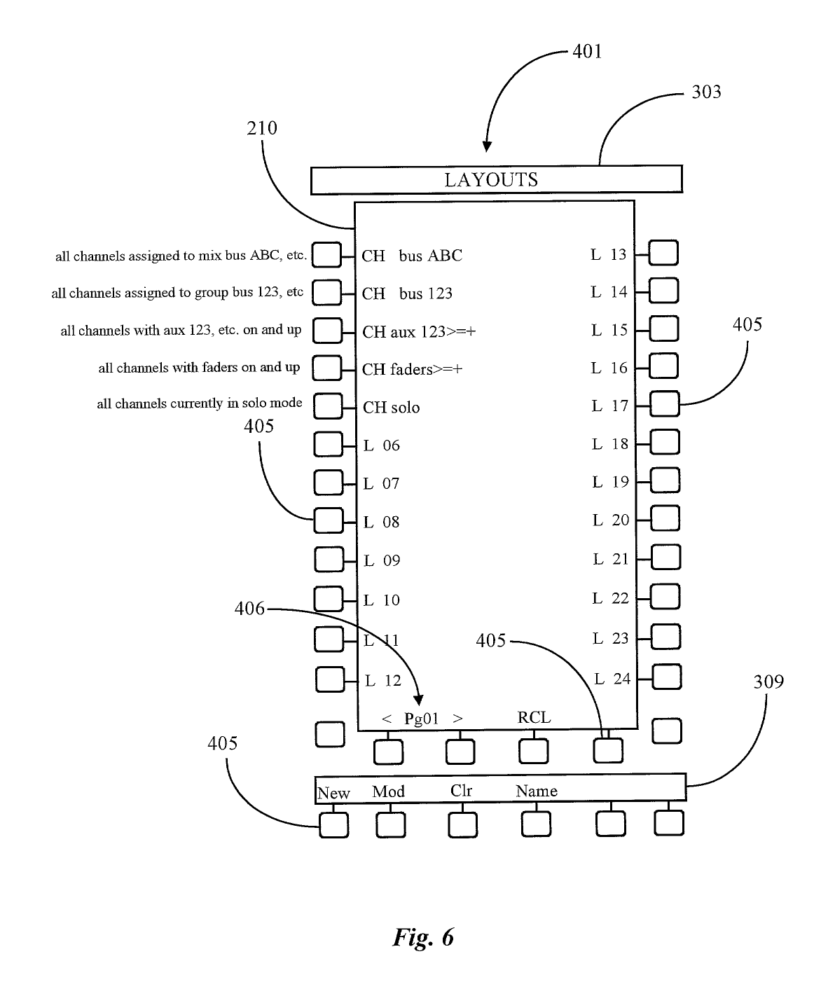

FIG. 6 is an enlarged view of the display panel of FIG. 2, showing a new and unique smart channel layout according to an embodiment of the present invention, which, in a preferred embodiment is incorporated into the pages, such as Layouts page, available for display and selection using the display panel 210 of FIG. 4, and the peripheral displays and input apparatus to that panel.

Panel viewer 401 is shown in FIG. 6, as are execute keys 405 and display strips 303 and 309 because the same interface used for conventional layouts previously described is used for the new smart layouts, as is subsequently described below. For simplicity, five different smart layouts are shown as saved and named in this example, although as with conventional layouts, many pages containing a multitude of smart layouts can be created and saved. The layout page displayed in this example can include not only channel names, but also a listing of a search criteria used in the layout, criteria reference next to the five execute keys 405 associated with the five new smart layouts.

In a preferred embodiment the smart layouts are not entered manually, but are a result of returns of a search function employed to discover channels fitting certain specific criteria. The first layout listed in FIG. 6 serves as a concrete example of this process. This layout is for all of the channels assigned to mix bus ABC. A search function is provided by programming by technicians or knowledge workers, and is available in the intelligent system. This search function is tagged with criteria and saved in the system with a name descriptive of the search criteria. In this case the name of the search function, hence the smart layout, is “CH bus ABC”.

Now, when an operator pages to the Smart Layouts page shown in FIG. 5, the specific instance of the search “CH bus ABC” is displayed, along with other instances of the search function enabled with other search criteria and also named according to their search criteria. Four other such instances are shown. These being “CH bus 123” with criteria to discover all channels connected to bus 123, “CH aux 123 >=+”, for which the search criteria is to discover all channels with auxiliary 123, that are also “on” and “up”, “CH faders >=+”, for which the search criteria is to discover al channels with faders on and up, and finally “CH solo”, for which the search criteria is to discover all channels currently in solo mode.

In the Layouts page previously described, when one presses a button next to a layout, the channels listed as stored in the particular layout are arrayed across a specified range or portion of the operating strips of the mixing desk. In the case of the Smart Layouts an more takes place. When one presses the button next to “CH bus 123 ”, there is no stored list of channels, instead, the search function is initiated, the search is conducted by the system through its myriad set of sensors and intelligence, a list of channels meeting the criteria is returned, and the discovered channels are arrayed to specified control strips along the mixing desk.

It now becomes apparent that a powerful new diagnostic tool is made available to users of the mixing system in embodiments of the present invention. The search tool for creating these Smart Layouts is not limited to specific sessions, for example, but available generally for any setup or occasion. Moreover, knowledge workers may program a very broad range of search functions for diagnostic purposes. In some cases fuzzy logic may be used as well, and criteria can become more general. With addition of and access to certain DSP devices, functionality can be provided for discovering which channels have a saxophone, for example, or which channels have a base beat over a certain first frequency but below a second frequency. The range is endless, and the power of the system to aid an operator in diagnosing problems in a mix is truly enormous. This power may even include criteria such as looking for the existence of a signal vs no signal etc.

Upon selection of one of these smart layouts by actuating the associated execute key 405, as briefly described above, the layout is recalled, in real-time, discovering and mapping all of the different channels that match the search condition set forth by the criteria attribute saved in the layout, starting at the left-most control strip and moving across the entire mixing console until all of the matching channels have been mapped, or following some other mapping criteria. In alternative embodiments of the present invention the user could select other points on the mixing console from which to recall the smart layout. For example, the user may wish to map only those channels matching the search criteria starting from the 10th control strip from the left, and so on. By utilizing such smart layouts to perform a channel search, the user, in effect, possesses a search function limited only by the elements and attributes of the current mixing system.

In an alternative embodiment of the present invention, the mixing engine can perform multiple smart layouts simultaneously. For instance, such a smart layout may contain search criteria for mapping of all channels assigned to mix bus A, and also for all channels with the fader set to a nonzero position. Such functionality could be assigned to an additional execute key. In this case the user would select the desired combination of smart layouts and then press the execute key to perform the mapping based on the selection criteria of the smart layouts. In other cases, the search criteria of the smart layout could be less clarified. For example, the user may wish to map only the channel with the loudest control setting, or the quietest setting, or the channel having a certain sound pattern, and so on. In still other alternative embodiments, future advancements of search logic could be incorporated into the system allowing even more vague search criteria to be used in the smart layout. As voice recognition improves in the future with advancing digital signal processing technologies the vagueness of such general searches can be dramatically increased. For example, utilizing such voice recognition, a user could verbally instruct the smart layout to perform a search for all channels with a recorded saxophone track, for instance, rather than having to recall specifically in which group or to which fader the saxophone is assigned. In other cases the search may be presented as a graph displayed in a display panel, which is part of the mixing desk, or the graph may be displayed by a computer monitor such as is currently known and used in the art. In yet other cases, rather than using the smart layout feature, a search can be conducted from an alphanumeric console typically present in such systems in the form of a PC (not shown).

It will be apparent to one with average skill in the art that many variations of the examples depicted and described without departing from the scope and spirit of the present invention. For example, it is well known that many more elements exist in a digital audio mixing system such as described, then are described in the various figures presented. Depiction and description of many such elements not pertinent to the present invention have been omitted for reasons of clarity and simplicity. It will also be apparent that many different search criteria can be used in the creation of smart layouts, limited only by the searchable elements and conditions present in the digital audio mixing system. It is for these reasons that the invention should be afforded the broadest possible scope, limited only by the claims that follow:

What is claimed is:

1. A diagnostic tool for an audio mixing system, comprising:
an information source storing at least interconnection characteristics and apparatus settings in the system, relative to channel inputs;
a search function accessible by a user, which upon initiation polls the information source; and
search criteria associated with the search function for establishing specific information to be matched in a search;
characterized in that initiation of the search function causes the search function to poll the information source, and to return channel numbers for those channels that match the search criteria.

2. The diagnostic tool of claim 1 further comprising monitoring interfaces to individual ones of channels in the audio mixing system, wherein the search function samples real-time characteristics at said interfaces in individual channels comparing the samples with search criteria.

3. The diagnostic tool of claim 2 wherein the monitoring interfaces include at least one audio monitoring interface, wherein the search function samples real-time audio in a channel for comparison to an audio characteristic specified in search criteria.

4. The diagnostic tool of claim 1 further comprising a facility for saving instances of the search function each with a name related to specific criteria attached, and for selecting and initiating individual ones of the named search functions to perform the associated search and to return channels found in the search.

5. The diagnostic tool of claim 4 wherein the facility for selecting and initiating comprises a display apparatus for displaying individual ones of the search functions by name and selection inputs for selecting individual ones of the displayed search functions, to initiate the associated search.

6. The diagnostic tool of claim 4 further comprising a function for assigning channels returned by a search to specific ones of control strips of the mixer desk.

7. An audio mixing system, comprising:
a mixer desk including a user interface and control apparatus;
a mixing engine coupled to the mixer desk for mixing audio on input channels and providing an audio output;
computerized controls for managing activities of the mixing system; and
a diagnostic tool including an information source storing at least interconnection characteristics and apparatus settings in the system, relative to channel inputs, a search function accessible by a user, which upon initiation polls the information source, and search criteria associated with the search function for establishing specific information to be matched in a search;
characterized in that initiation of the search function causes the search function to poll the information source, and to return channel numbers for those channels that match the search criteria.

8. The system of claim 7 further comprising monitoring interfaces to individual ones of channels in the audio mixing system, wherein the search function samples real-time characteristics at said interfaces in individual channels comparing the samples with search criteria.

9. The system of claim 8 wherein the monitoring interfaces include at least one audio monitoring interface, wherein the search function samples realtime audio in a channel for comparison to an audio characteristic specified in search criteria.

10. The system of claim 7 further comprising a facility for saving instances of the search function each with a name related to specific criteria attached, and for selecting and initiating individual ones of the named search functions to perform the associated search and to return channels found in the search.

11. The system of claim 10 wherein the facility for selecting and initiating comprises a display apparatus for displaying individual ones of the search functions by name and selection inputs for selecting individual ones of the displayed search functions, to initiate the associated search.

12. The system of claim 10 further comprising a function for assigning channels returned by a search to specific ones of control strips of the mixer desk.

13. A method for diagnosing problems in an audio mixing system having individual channels for audio inputs to the system, comprising the steps of:
(a) preparing a generic search function capable of polling an information source in the system, the information source storing at least interconnection characteristics and apparatus settings in the system, relative to channel inputs;
(b) assigning search criteria to individual instances of the generic search function, creating thereby specific search functions; and
(c) initiating individual ones of the specific search functions to poll the information source, and to return channel numbers for those channels that match the specific search criteria.

14. The method of claim 13 further comprising monitoring interfaces to individual ones of channels in the audio mixing system, wherein, in step (c), the search function samples real-time characteristics at said interfaces in individual channels comparing the samples with the search criteria.

15. The method of claim 14 wherein the monitoring interfaces include at least one audio monitoring interface, wherein the search function samples real-time audio in a channel for comparison to an audio characteristic specified in search criteria.

16. The method of claim 13 further comprising a facility for saving instances of the search function each with a name related to specific criteria attached, and for selecting and initiating individual ones of the named search functions to perform the associated search and to return channels found in the search.

17. The method of claim 16 wherein the facility for selecting and initiating comprises a display apparatus for displaying individual ones of the search functions by name and selection inputs for selecting individual ones of the displayed search functions, to initiate the associated search.

18. The method of claim 16 further comprising a function for assigning channels returned by a search to specific ones of control strips of the mixer desk.
